(19) United States
(12) Patent Application Publication
(10) Pub. No.: US 2007/0066256 A1
(43) Pub. Date: Mar. 22, 2007

(54) Apparatus and method for receiving multi band signals in a mobile communication system

(75) Inventor: Min-Kyung Lee, Suwon-si (KR)

Correspondence Address: DILWORTH & BARRESE, LLP, 333 EARLE OVINGTON BLVD., SUITE 702, UNIONDALE, NY, 11553, US

(73) Assignee: Samsung Electronics Co., Ltd.

(21) Appl. No.: 11/514,451

(22) Filed: Sep. 1, 2006

(30) Foreign Application Priority Data
Sep. 22, 2005 (KR) 2005-88143

(51) Int. Cl. H04B 1/18

(52) U.S. Cl. 455/188.1; 455/168.1

(57) ABSTRACT

An apparatus and method for receiving multi band signals in a mobile communication terminal are disclosed. The apparatus includes a tunable band pass filter for selecting a band signal among Radio Frequency (RF) band signals received through an antenna using switched capacitors and a tunable switching low noise amplifier for impedance matching the band signal from the filter using the switched capacitors at selected level, and low-noise amplifying the band signal.

### PRIORITY

This application claims priority under 35 U.S.C. § 119 to an application entitled “Apparatus For Receiving Multi Band Signals In A Mobile Communication System” filed in the Korean Intellectual Property Office on Sep. 22, 2005 and assigned Serial No. 2005-88143, the contents of which are incorporated herein by reference.

### BACKGROUND OF THE INVENTION

1. Field of the Invention

The present invention relates to a mobile communication terminal, in particular, to an apparatus and method for receiving low power multi band signals using a switching element in a mobile communication system.

2. Description of the Related Art

Along with an increase in mobile communication subscribers, the mobile communication service market is rapidly increasing. Replacement of mobile communication system equipment is expected to increase due to the introduction of technologies such as data packet transmission service, WAP (wireless application protocol), and Bluetooth. Thus, the mobile communication device market is also continually increasing.

Along with such development of the mobile communication technology, mobile communication service providers now face a frequency resource issue. The issue is a concern among international mobile communication service providers as well as among domestic mobile communication service providers. For example, a cellular type mobile communication service uses 800 MHz frequency band, a Personal Communication Service (PCS) uses 1.8 GHz frequency band, an IMT-2000 (International Mobile Telecommunication-2000) service uses 2 GHz frequency band. As with the increase in service frequency band, transmission/reception devices for increasing or reducing a frequency of signals for digital modulation are significantly studied.

FIG. 1 illustrates an example of configuration of a conventional multi band signal reception device in a mobile communication system. The multi band signal reception device is implemented by connecting reception ends 100, 110 and 120 in parallel respectively to each corresponding band by switching. The reception ends 100, 110 and 120 include Radio Frequency (RF) band pass filters 101, 111 and 121, Low Noise Amplifiers (LNA) 103, 113 and 123 and Mixers 105, 115 and 125.

Referring to FIG. 1, RF band signals received through an antenna 130 are input to RF band pass filters 101, 111 and 121. The RF band pass filters 101, 111 and 121 filter the signals received through the antenna 130 and send filtered signals to LNAs 103, 113 and 123. The LNAs 103, 113 and 123 low-frequency amplify the signals on a predetermined gain rate, and send the amplified signals to Mixers 105, 115 and 125. The Mixers 105, 115 and 125 mix the signals from the LNA 103, 113 and 123 with sinusoidal signals from a local oscillator and transfer the mixed signal to an intermediate frequency band signal. The signal from the Mixers 105, 115 and 125 are input to a base band modem (not shown) through an intermediate frequency filter and an intermediate frequency/automatic gain control amplifier (not shown).

Since the conventional RF signal reception device has RF band pass filters 101, 111 and 121 having fixed frequency properties, it switches reception ends 100, 110 and 120 corresponding to each band in order to process the received multi band signals. Therefore, a number of reception ends are needed and thus the reception device is large and the resultant manufacturing costs are high. That is, the parallel multi band reception device does not have an advantage over separate reception devices corresponding to each band in view of the element number, implementing space and power consumption.

FIG. 2 illustrates another multi band signal reception device of a conventional mobile communication system. The multi band reception device illustrated in FIG. 2 has been proposed in order to solve the problems of the multi band signal reception device shown in FIG. 1.

Referring to FIG. 2, the multi band signal reception device has parallel multi RF band pass filters 201, 203 and 205 to process each band signal because they are difficult to obtain broadband properties. But it shares a low noise amplifier (LNA) 207 and a mixer 209 to process filtered signals. Here, low noise amplifier (LNA) 207 uses a broadband RF circuit covering entire bands and mixer 209 uses a broadband RF circuit covering entire bands. There is an advantage of reducing the element numbers or an implementing space, whereas there are disadvantages that more power consumption is needed to obtain wider bandwidth. RF noise performance also becomes worse due to the use of resist matching for broadband matching.

### SUMMARY OF THE INVENTION

Therefore, in order to solve above identified problems, there is a need to provide an apparatus for receiving multi band signals which has lesser elements, less space, improved noise performance and less power consumption.

Accordingly, an object of the present invention is to provide an apparatus for receiving low power multi band signals using switching elements in a mobile communication system.

Another object of the present invention is to provide an apparatus for receiving low power multi band signals using a tunable RF band pass filter and a tunable switching LNA in a mobile communication system.

According to the present invention, for achieving the above objects, in an apparatus of multi band reception, a band pass filter for selecting a band signal among Radio Frequency (RF) band signals received through an antenna using switched capacitors, and a tunable switching low noise amplifier for impedance matching the band signal from the filter using the switched capacitors at selected level and low-noise amplifying the band signal are provided.

### BRIEF DESCRIPTION OF THE DRAWINGS

The above and other objects, features, and advantages of the present invention will become more apparent from the following detailed description when taken in conjunction with the accompanying drawings in which:

FIG. 1 illustrates a multi band signal reception apparatus in a conventional mobile communication system;

FIG. 2 illustrates another multi band signal reception apparatus in a conventional mobile communication system;

FIG. 3 illustrates the configuration of a multi band signal reception apparatus in a mobile communication system according to the present invention;

FIG. 4 is a circuit diagram of a tunable band pass filter using switched capacitors according to the present invention;

FIG. 5 is a circuit diagram of a switching low noise amplifier (switching LNA) using switched capacitors according to the present invention; and

FIG. 6 is an illustration showing a simulation result on a gain at a reception end using a switching low noise amplifier according to the present invention.

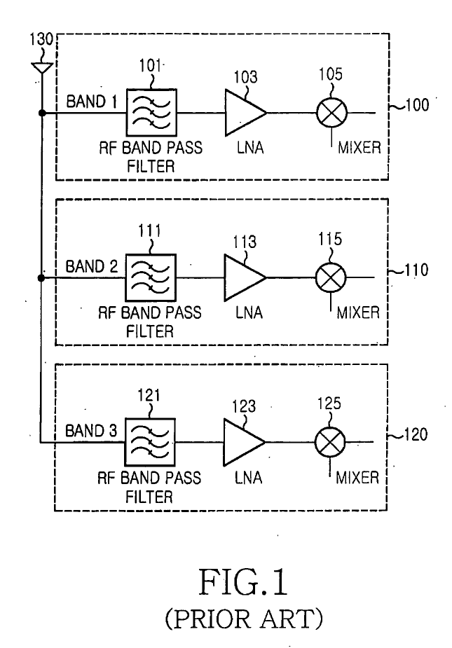

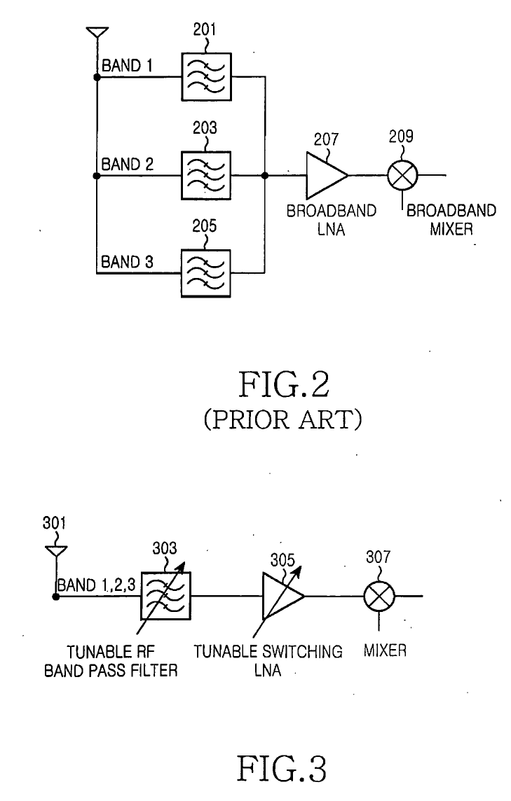

### DETAILED DESCRIPTION OF THE PREFERRED EMBODIMENTS

Preferred embodiments of the present invention will be described herein below with reference to the accompanying drawings. In the following description, well-known functions or constructions are not described in detail.

Hereinafter, an apparatus for receiving multi band reception in a mobile communication system according to the present invention will be described.

FIG. 3 illustrates the configuration of a multi band reception apparatus in a mobile communication system according to the present invention. The multi band reception apparatus includes an antenna 301 for receiving RF signals of a number of bands, a tunable RF band pass filter 303 for selecting a RF signal corresponding to one band from the RF signals, a tunable switching low noise amplifier (LNA) 305 for low-noise amplifying the selected RF signal from the filter 303, and a mixer 307 for mixing the amplified RF signal from the amplifier 305 and an sinusoidal signal from an oscillator to generate an intermediate frequency (IF) signal.

The antenna 301 receives weak RF signals having different frequency bands transmitted from different mobile communication devices. The tunable RF band pass filter 303 passes one frequency signal selected by a user among the RF signals received through the antenna 301. Here, the tunable RF band pass filter 303 selects a pass band corresponding to a band frequency selected by the user using a number of switched capacitors. That is, the tunable RF band pass filter 303 filters a signal of a frequency band selected by the user among a plurality of frequency band signals received through the antenna 301 by band switching using switched capacitors, and removes unnecessary signal components.

The tunable switching low noise amplifier (switching LNA) 305 low-noise-amplifies the RF signal from the tunable RF band pass filter 303 at a predetermined gain according to each frequency band by band matching using switched capacitors, and outputs the amplified signal to a mixer 307. The mixer 307 mixes the amplified signal with a sinusoidal signal generated from the local oscillator and generates an intermediate frequency (IF) wave signal.

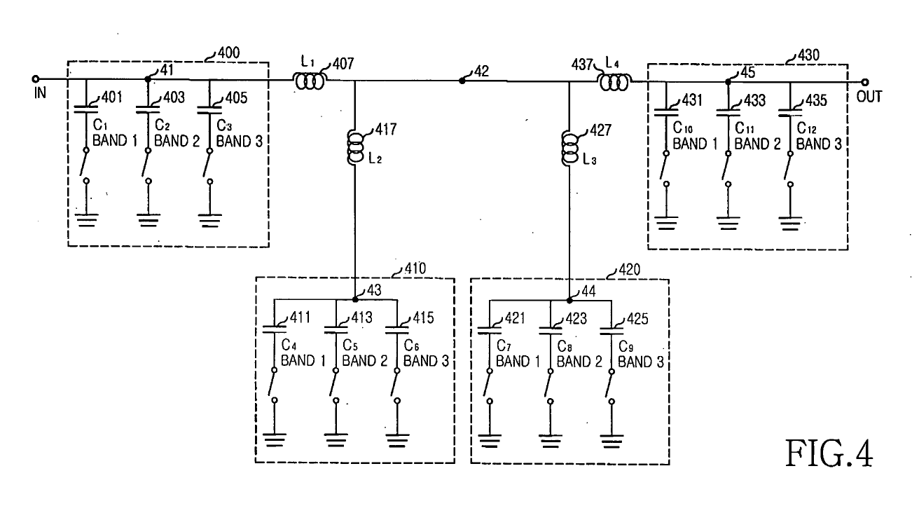

FIG. 4 is a circuit diagram of a tunable RF band pass filter using switched capacitors according to the present invention. Here, the tunable RF band pass filter includes a number of switched capacitor blocks (a first switched capacitor block 400, a second switched capacitor block 410, a third switched capacitor block 420 and a fourth switched capacitor block 430) and a number of inductors (a first inductor L₁ 407, a second inductor L₂ 417, a third inductor L₃ 427 and a fourth inductor L₄ 437).

Referring to FIG. 4, in a circuit of the tunable RF band pass filter 303, both the first switched capacitor stage 400 and one end of the first inductor L₁ 407 are connected to an input end (node 41). The other end of the first inductor L₁ 407 (node 42) is connected to one end of the second inductor L₂ 417, one end of the third inductor L₃ 427 and one end of the fourth inductor L₄ 437. The other end (node 43) of the second inductor L₂ 417 is connected to the second switched capacitor stage 410. The other end (node 44) of the third inductor L₃ 427 is connected to the third switched capacitor stage 420. The other end (node 45) of the fourth inductor L₄ 437 is connected to the fourth switched capacitor stage 430 and an output end of the tunable RF band pass filter circuit.

The first, second, third and fourth switched capacitor stages 400, 410, 420 and 430 include switched capacitors corresponding to a number of specific bands. For example, each switched capacitor stage 400, 410, 420 and 430 includes three switched capacitors corresponding to each of three bands, i.e. band 1, band 2, band 3.

In a detailed circuit configuration of the first switched capacitor stage 400, one end (node 41) of the first switched capacitor stage 400 is commonly connected to a first switched capacitor C₁ 401 corresponding the band 1, a second switched capacitor C₂ 403 corresponding the band 2, a third switched capacitor C₃ 405 corresponding the band 3. The other ends of each switched capacitor C₁ 401, C₂ 403 and C₃ 405 is serially connected to their corresponding respective switches. The respective switches pass or block each switched capacitors. Here, the switch is turned on/off according to control of a modem (not shown) and the other end of the switch is connected to a ground. The corresponding switched capacitor is charged when the switch is turned on, and is discharged when the switch is turned off. An equivalent capacitance of the circuit can be controlled by turning on/off the switch of the switched capacitor. Therefore, a bandwidth can be extended.

The configuration of circuits of the second, third and fourth switched capacitor stages 410, 420 and 430 is the same as that of the first switched capacitor stage 400. That is, the second switched capacitor stage 410 includes a fourth switched capacitor C₄ 411 corresponding to the band 1, a fifth switched capacitor C₅ 413 corresponding to the band 2 and a sixth switched capacitor C₆ 415 corresponding to the band 3. The third switched capacitor stage 420 includes a seventh switched capacitor C₇ 421 corresponding to the band 1, a eighth switched capacitor C₈ 423 corresponding to the band 2 and a ninth switched capacitor C₉ 425 corresponding to the band 3. The fourth switched capacitor stage 430 includes a tenth switched capacitor C₁₀ 431 corresponding to the band 1, a eleventh switched capacitor C₁₁ 433 corresponding to the band 2 and a twelfth switched capacitor C₁₂ 435 corresponding to the band 3. Here, the switched capacitor may be implemented by a Metal-Insulator-Metal (MIM) capacitor or a Metal-Oxide-Silicon (MOS) capacitor.

Hereby, the tunable RF band pass filter 303 switches a switching element separately in each band according to a control signal of the modem using the switched capacitor. Then, a pass band is selected according to a band frequency selected by a receiver. The selected band is input to an input end of the switching LNA 305.

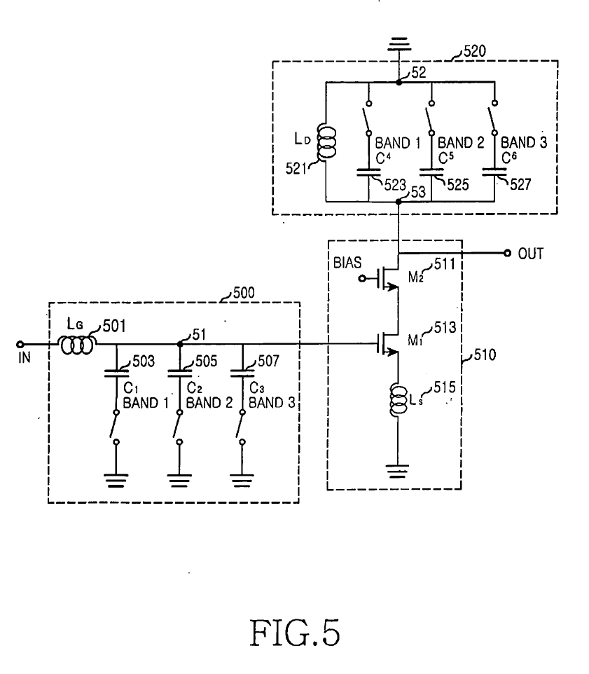

FIG. 5 is a circuit diagram of a tunable switching low noise amplifier (switching LNA) 305 using switched capacitors according to the present invention. A circuit of the switching LNA 305 includes a switching matching circuit 500 for input impedance matching, an amplification stage 510 and a switching load impedance stage 520 for load impedance matching.

Referring to FIG. 5, the switching matching circuit 500, which is a circuit for input impedance matching, selects an input impedance matching value corresponding to a band frequency selected by a user using a switched capacitor which is controlled by the modem (not shown). Thus, the switching matching circuit 500 at the input end of the LNA 305 performs impedance matching on an input signal at the selected level and sends the input signal to the amplification stage 510.

In the switching matching circuit 500, an input end (IN) is connected to one end of a first inductor L_{G} 501. The other end (node 51) of the first inductor L_{G} 501 is commonly connected to a number of ends of switched capacitors C₁, C₂ and C₃ 503, 505 and 507. The other ends of each switched capacitor C₁ 503, C₂ 505 and C₃ 507 are connected serially to their respective switches. The respective switches pass or block each switched capacitor. Here, the switch is turned on/off according to control of a modem (not shown) and the other end of the switch is connected to a ground. The corresponding switched capacitor is charged when the switch is turned on, and is discharged when the switch is turned off. An equivalent capacitance of the circuit can be controlled by turning on/off the switches of the switched capacitors 503, 505 and 507. Therefore, a bandwidth can be extended.

When a frequency corresponding to a specific band is supplied to the input end (IN), capacitors connected in serial to a switch are turned on according to a control of the model among the switched capacitors C₁, C₂ and C₃ 503, 505 and 507. For example, in case that only the switch connected to the other end of the switched capacitor C₁ 503 is turned on according to the control of the modem, a conduction path of the switch provides an impedance conduction path of the capacitor C₁ 503 and the other end of the capacitor C₁ 503 is clamped to a ground. Therefore, the capacitor C₁ 503 has a voltage (e.g. 15V) supplied to one end and a voltage of 0V supplied to the other end. Both ends of the capacitor C₁ 503 are charged with +V (e.g. 15V).

The amplification stage 510, which includes two transistors M₁ 513 and M₂ 511 and a second inductor L_{S} 515, amplifies a low power reception signal supplied through the switching matching circuit 500. A drain of the transistor M₂ 511 is connected to a node 53. A source of the transistor M₂ 511 is connected to the drain of the transistor M₁ 513. A gate of the transistor M₂ 511 is connected to a bias supplying a predetermined voltage. Here, the transistor M₂ 511 operates as a static voltage supplying means for supplying a stable bias voltage to the transistor M₁ 513 on the basis of the predetermined voltage. That is, when the transistor M₂ 511 is turned on, a potential of the node 53 is supplied to the drain of the transistor M₁ 513. Here, the drain (node 53) of the transistor M₂ 511 is connected to an output end (OUT) of the switching LNA 305 connected to an input end of the Mixer 307. The drain of the transistor M₁ 513 is connected to the source of the transistor M₂ 511. The source of the transistor M₁ 513 is connected to one end of the second inductor L_{S} 515. A gate of the transistor M₁ 513 is connected to the other end (node 51) of the first inductor L_{G} 501. When the transistor M₁ 513 is turned on, the potential of the drain is supplied to one end of the second inductor L_{S} 515.

The switching load impedance stage 520, which is a circuit for load impedance matching, selects an output impedance matching element using the switched capacitor controlled by the modem to match a band frequency selected by the user. Then, the switching load impedance stage 520 performs the impedance matching the amplified signal at the selected level and outputs the amplified signal through an output end (OUT).

In the switching load impedance stage 520, a node 52 which is supplied a voltage from a source is commonly connected to a number of parallel switches and one end of a third inductor L_{D} 521. The other end of each switch is serially connected to corresponding switched capacitors C₄ 523, C₅ 525 and C₆ 527. The respective switches pass or block each of the switched capacitors. The third inductor L_{D} 521 and the other end of the switched capacitors C₄ 523, C₅ 525 and C₆ 527 are connected to the node 53. Here, the switch is turned on/off according to control of the modem and the corresponding switched capacitors C₄ 523, C₅ 525 and C₆ 527 are charged when the switch is turned on, and is discharged when the switch is turned off. An equivalent capacitance of the circuit can be controlled by turning on/off the switches of the switched capacitors C₄ 523, C₅ 525 and C₆ 527. Therefore, a bandwidth can be extended.

Here, the switched capacitor may be implemented with a Metal-Insulator-Metal (MIM) capacitor or a Metal-Oxide-Silicon (MOS) capacitor.

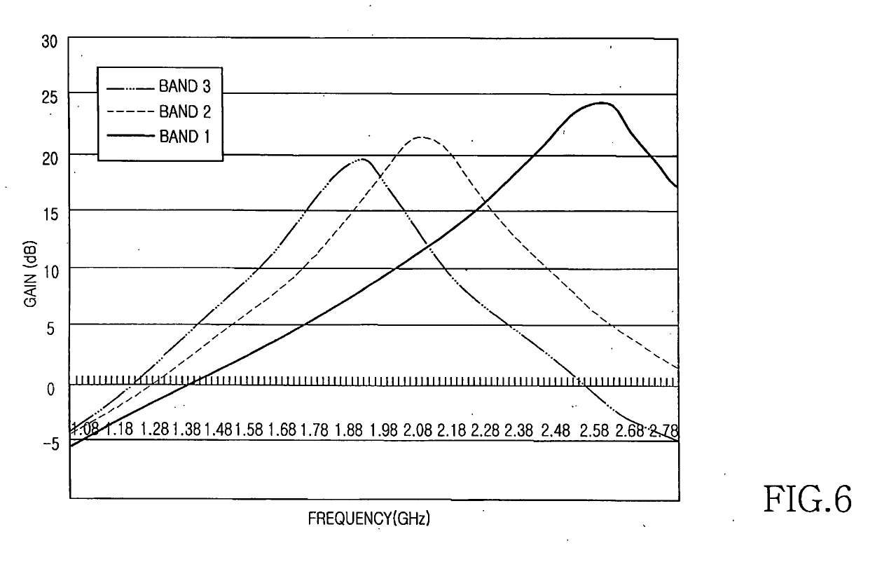

FIG. 6 is an illustration showing a simulation result on a gain at a reception end using a switching low noise amplifier according to the present invention.

Referring to FIG. 6, it is shown that multi band reception according to user's selection using the switching low noise amplifier comprising a tunable RF switched capacitor is possible. Here, a gain is over nearly 20 dB.

The present invention provides a multi band reception device comprising a tunable RF band pass filter and a tunable LNA circuit in a mobile communication terminal. Thus, there is an advantage of significantly reducing an implementing area and costs. Accordingly, there are advantages of operating with low power and improved noise performance.

While the present invention has been shown and described with reference to certain preferred embodiments thereof, it will be understood by those skilled in the art that various changes in form and details may be made therein without departing from the spirit and scope of the present invention as defined by the appended claims.

What is claimed is:

1. A mobile communication terminal including an apparatus for receiving multi band, said apparatus comprising:
a tunable band pass filter for selecting a band signal among Radio Frequency (RF) band signals received through an antenna using switched capacitors; and
a tunable switching low noise amplifier for low-noise amplifying the selected band signal from the tunable band pass filter.

2. The mobile communication terminal of claim 1, the apparatus further comprising:
a mixer for mixing the low-noise amplified signal from the amplifier with a sinusoidal signal from a local oscillator and transferring the mixed signal to an intermediate frequency band.

3. The mobile communication terminal of claim 1, wherein the switched capacitor is one of a Metal Insulator Metal (MIM) capacitor and a Metal Oxide Silicon (MOS) capacitor.

4. The mobile communication terminal of claim 1, wherein the tunable switching low noise amplifier comprises:
a switching matching circuit for performing impedance matching on the selected band signal from the tunable band pass filter;
an amplification stage for amplifying the impedance matched signal; and
a switching load impedance stage for performing impedance matching on the amplified signal.

5. The mobile communication terminal of claim 4, wherein in the switching matching circuit, an input end is connected to one end of a first inductor, and the other end of the first inductor is commonly connected to one end of a plurality of switched capacitors, and the other end of each of the switched capacitors is serially connected to a corresponding switch.

6. The mobile communication terminal of claim 5, wherein each switch is turned on/off according to a control of a modem.

7. The mobile communication terminal of claim 5, wherein in the switching load impedance stage, each one end of a number of switches and one end of a third inductor are commonly connected to a power source, the other ends of each switch are serially connected to corresponding switched capacitors, and the other end of the third inductor and the other end of the switched capacitors are commonly connected to an output end.

8. The mobile communication terminal of claim 7, wherein each switch is turned on/off according to the control of a modem.

9. The mobile communication terminal of claim 4, wherein the amplification stage includes:
an amplifier for low-noise amplifying a reception signal from the switching matching circuit; and
a constant voltage supplier for supplying a stable bias voltage to the amplifier on the basis of a predetermined DC power source.

10. The mobile communication terminal of claim 9, wherein the amplifier comprises an amplification stage including two transistors and an inductor.

11. The mobile communication terminal of claim 1, wherein switches in the tunable band pass filter are turned on/off according to the control of a modem.

12. A method of receiving multi band signals in a mobile communication terminal comprising:
selecting a band signal among Radio Frequency (RF) band signals received through an antenna using switched capacitors; and
low-noise-amplifying the selected band signal.

13. The method of claim 12, further comprising:
mixing the low-noise amplified signal with a sinusoidal signal from a local oscillator; and
transferring the mixed signal to an intermediate frequency band.

14. The method of claim 12, wherein the switched capacitor is one of a Metal Insulator Metal (MIM) capacitor and a Metal Oxide Silicon (MOS) capacitor.

15. The method of claim 12, wherein the low-noise-amplifying step comprises:
performing impedance matching on the selected band signal;
amplifying the impedance matched signal; and
performing impedance matching on the amplified signal.
